(19) United States
(12) Patent Application Publication
(10) Pub. No.: US 2014/0222692 A1
(43) Pub. Date: Aug. 7, 2014

(54) CONTEXTUAL HETEROGENEOUSLY SOURCED DATA RETRIEVAL AND DISPLAY

(71) Applicant: SUGARCRM INC., Cupertino, CA (US)

(72) Inventors: Lila Tretikov, Los Gatos, CA (US); Majed Itani, San Jose, CA (US); Lam Huyn, Houston, TX (US); Wes Moran, Merrimack, NH (US)

(73) Assignee: SugarCRM Inc., Cupertino, CA (US)

(21) Appl. No.: 13/760,766

(22) Filed: Feb. 6, 2013

(51) Int. Cl. G06Q 30/02

(52) U.S. Cl. CPC G06Q 30/02
USPC 705/304

(57) ABSTRACT

A method for displaying contextually relevant heterogeneously sourced data in a business application includes generating a user interface for a business application comprising a display of a record of a contact stored in a local data store and determining a context for the contact. The method also includes retrieving contextually relevant data according to the context from both the local data store that is part of the business application and also an external data source that is external to the business application from over a computer communications network. Finally, the method includes displaying the contextually relevant data from the local data store in a panel adjacent to the display of the record of the contact in the user interface, and also the contextually relevant data from the external data source in an additional panel adjacent to the display of the record of the contact in the user interface.

### BACKGROUND OF THE INVENTION

1. Field of the Invention

The present invention relates to the mining of business intelligence and more particularly to the retrieval and display contextual relevant data in a business intelligence application.

2. Description of the Related Art

Business intelligence refers to the computerized observation of business related data and the analytical reduction of the business related data into a form requisite for supporting business activities. In a customer relationship management (CRM) application, for example, business intelligence is evident in the presentation in a display of summarized data for a customer or potential customer based upon more granular data present within the CRM application. Business intelligence, then, can provide a substantial advantage to the end user who otherwise would be required to reduce enormous quantities of data manually without benefit of computer logic.

Business intelligence traditionally has been limited to the simplification of a set of data into summarized form for visual presentation to the end user. A classic example of a legacy application of business intelligence is the detection and presentation as a reminder of a birthday or anniversary of a customer or potential customer to a sales representative. However, the simplified nature of business intelligence as described cannot suffice in a modern world of global commerce where vast amounts of data are not captured internally to a particular business application, business intelligence. Rather, oftentimes the most critical information necessary for reduction as business intelligence remains external to a business application requiring the end user to use resourcefulness and basic tools such as Web browsers to identify, retrieve and process the requisite business intelligence.

Recently, sophisticated contact management applications have incorporated a component that detects a contact record selected for viewing and retrieves from over the Internet a related contact record from a different application. Thereafter, the data from the contact record of the different application can be permanently linked to the selected contact record as if the data from the contact record of the different application were part and parcel of the selected contact record. However, business intelligence persistent externally to an application changes daily and is present in a variety of disparate sources also changing with great frequency. Further, notwithstanding the vast ocean of business intelligence present externally to an application, an equally robust store of business intelligence remains present internally to the application where the application hosts a multiplicity of end users constantly posting new data and modifying existing data in the application.

### BRIEF SUMMARY OF THE INVENTION

Embodiments of the present invention address deficiencies of the art in respect to business intelligence and provide a novel and non-obvious method, system and computer program product for displaying contextually relevant heterogeneously sourced data in a business application. In an embodiment of the invention, a method for displaying contextually relevant heterogeneously sourced data in a business application can include generating a user interface for a business application comprising a display of a record of a contact stored in a local data store and determining a context for the contact. The method also can include retrieving contextually relevant data according to the context from both the local data store that is part of the business application and also an external data source that is external to the business application from over a computer communications network. Finally, the method can include displaying the contextually relevant data from the local data store in a panel adjacent to the display of the record of the contact in the user interface, and also the contextually relevant data from the external data source in an additional panel adjacent to the display of the record of the contact in the user interface.

In another embodiment of the invention, a business data processing system is configured for displaying contextually relevant heterogeneously sourced data. The system includes a host computing system with memory and at least one processor and a business application executing in the memory of the host computing system and providing a user interface comprising a display of a record of a contact stored in a local data store. The system also includes a contextual data retrieval module coupled to the business application. The module includes program code enabled to determine a context for the contact, to retrieve contextually relevant data according to the context from both the local data store that is part of the business application and also an external data source that is external to the business application from over a computer communications network, and to direct the business application to display the contextually relevant data from the local data store in a panel adjacent to the display of the record of the contact in the user interface, and also the contextually relevant data from the external data source in an additional panel adjacent to the display of the record of the contact in the user interface.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for displaying contextually relevant heterogeneously sourced data in a business application;

FIG. 2 is a schematic illustration of a business data processing system configured for displaying contextually relevant heterogeneously sourced data; and,

FIG. 3 is a flow chart illustrating a process for displaying contextually relevant heterogeneously sourced data in a business application.

### DETAILED DESCRIPTION OF THE INVENTION

Embodiments of the invention provide for displaying contextually relevant heterogeneously sourced data in a business application. In accordance with an embodiment of the invention, a record can be selected for display in a user interface of a business application. A context can be determined for the record that can include a contact name of a customer or a potential customer, a business name for a business enterprise associated with the contact name, an industry type for the business enterprise type, a geographical location of the business enterprise, and the like. Thereafter, the context can be used to query both data stores internal to the business application and also at least one external data store, such as a Web site in order to aggregate business intelligence. In this regard, the business intelligence can include by way of example, internally or externally sourced transactions that have occurred with other business enterprises of the same industry type, externally sourced company data, or externally sourced recent news for the contact name, business enterprise, industry type or geographical location.

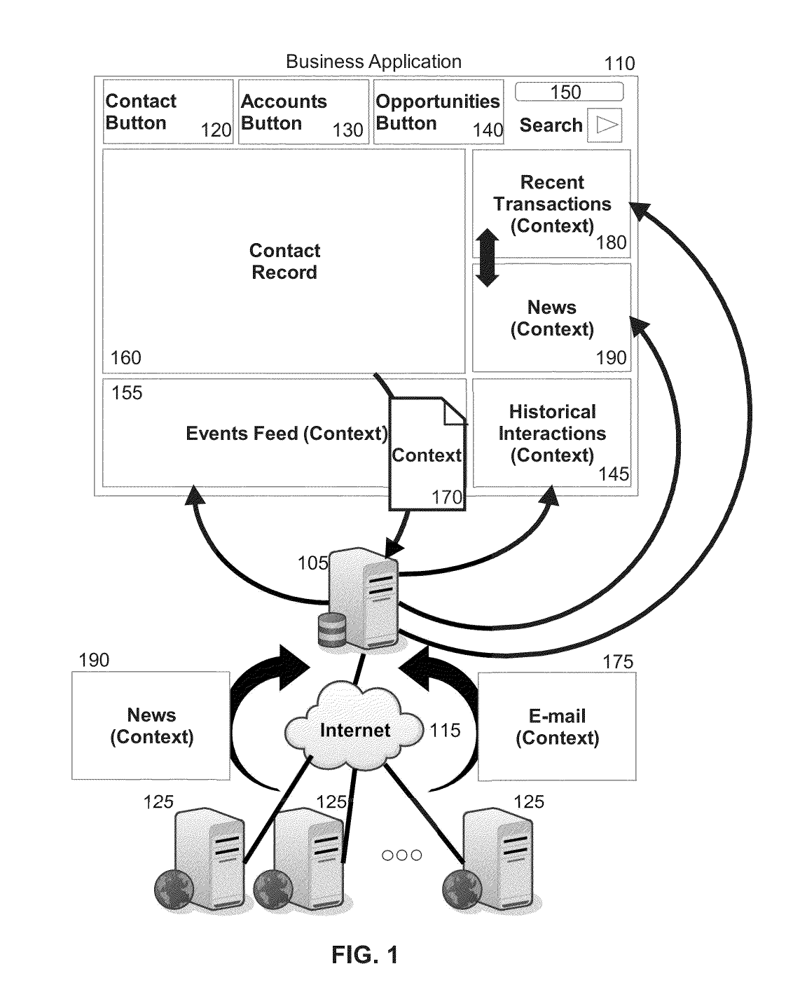

In further illustration, FIG. 1 is a pictorial illustration of a process for displaying contextually relevant heterogeneously sourced data in a business application. As shown in FIG. 1, a business application 110 can be provided in a computing system 105 and can include a user interface in which a selected contact record 160 is displayed. The contact record 160 can be selected through the operation of contact button 120 by which a set of selectable contacts can be presented, or through a search field 150 which a contact can be located by query. An accounts button 130 also can be provided in the user interface of the business application 110 responsive to the activation of which a set of existing customers can be presented and an individual one of the customers selected for display as the contact record 160. Similarly, an opportunities button 140 can be provided in the user interface of the business application 110 responsive to the activation of which a set of potential customers can be presented and an individual one of the potential customers selected for display as the contact record 160.

Of note, a context 170 can be retrieved for the displayed contact record 160. The context 170 can include contextual data relating to the displayed contact record 160, that can include a contact name of a customer or a potential customer, a business name for a business enterprise associated with the contact name, an industry type for the business enterprise type, a geographical location of the business enterprise, and the like. The context 170 subsequently can be processed in the computing system 105 to query data of the business application 110 in order to produce a panel display of recent transactions 180 for business enterprises related to that of the context 170, or for a contact related to that of the context 170.

The context 170 likewise can be processed in the computing system 105 to query data of the business application 110 in order to produce a panel display of historical interactions 145 related to a contact or a business enterprise of the contact indicated by the context 170. Of note, the context 170 also can be processed in the computing system 105 to query external data sources 125 over the global Internet 115 in order to produce a panel display of news items 190 for insertion into the user interface of the business application 110. Yet further, the context 170 can be processed in the computing system 105 to query data of the business application 110 in order to produce a panel of a real-time feed of events 155 related to a contact or a business enterprise of the contact indicated by the context 170. Even yet further, the context 170 can be processed in the computing system 105 to query external data sources 125 over the global Internet 115 in order to retrieve e-mail messages 175 related to the context 170 such as e-mail messages to or from individuals referenced in the context 170, or including content or a subject line referenced in the context 170.

Of note, the panels 145, 155, 180, 190 can be re-rendered with new data whenever a change is detected in the context record 160 resulting in a new context 170. Further, the panels 145, 155, 180, 190 can be re-rendered with new data whenever a change is detected in another one of the panels 145, 155, 180, 190. For example, internal data can be generated concurrent with the display of the contact record 160 such that the data in the panel of recent transactions 180 changes to account for the new data. Subsequently, the panel of news 190 can be sourced from the external data source 125 to account for the new data in the panel of recent transactions 180. In this way, business intelligence can be provided in the business application 110 so as to be contextually relevant to the data of the contact record 160 irrespective of whether the business intelligence is sourced from a local data store of the computing system 105, or whether the business intelligence is sourced from the external data sources, or both.

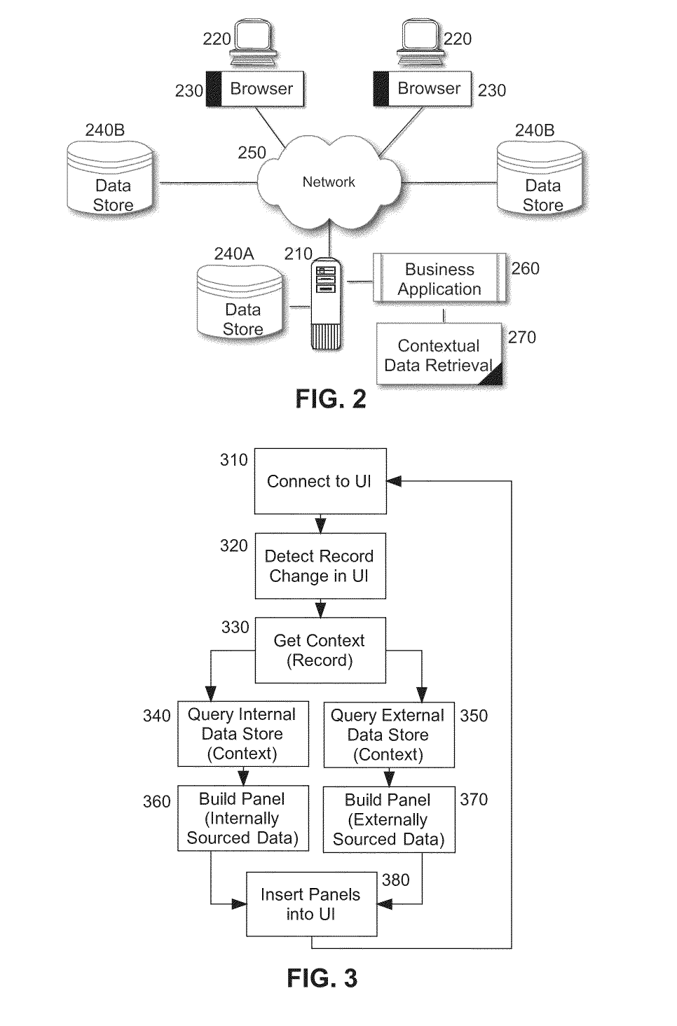

The process described in connection with FIG. 1 can be implemented in a business data processing system. In further illustration, FIG. 2 schematically shows a business data processing system configured for displaying contextually relevant heterogeneously sourced data. The system can include a host computing system 210 that can include one or more different servers each with memory and at least one processor (only a single server shown for the purpose of illustrative simplicity). The host computing system 210 can support the operation of a business application 260 storing data locally in data store 240A. The host computing system 210 also can be coupled over computer communications network 250 to different clients 220, each with a corresponding browser 230 through which the business application 260 can be concurrently accessed by multiple different end users.

A contextual data retrieval module 270 can be coupled to the business application 260. The contextual data retrieval module 270 can include program code enabled upon execution in the host computing system 210 to respond to a change in a display of a contact in a user interface of the business application 260, by determining a context for the contact, retrieving contextually relevant data from both the data store 240A and also one or more external data stores 240B accessible from over the network 250, and displaying the contextually relevant data in the user interface adjacent to the display of the contact.

The contextually relevant data can include news items for individuals or business entities related to the contact, past transactions which have transpired with individuals or business enterprises related to the contact, past transactions which have transpired with the contact, and events occurring within the business application 260 resulting from the actions of other end users of the business application 260. Of note, the program code of the contextual data retrieval module 270 also can be enabled to respond to a change in a display of the contextually relevant data in the user interface of the business application 260, by determining a context for the contextually relevant data, retrieving additional contextually relevant data from both the data store 240A and also one or more external data stores 240B accessible from over the network 250, and displaying the additional contextually relevant data in the user interface adjacent to the display of the contact.

In even yet further illustration of the operation of the contextual data retrieval module 270, FIG. 3 is a flow chart illustrating a process for displaying contextually relevant heterogeneously sourced data in a business application. Beginning in block 310, a connection can be established with a user interface of a business application and in block 320, a record change displayed in the user interface can be detected. In block 330, a context can be determined for the record. Thereafter, in block 340 an internal data store can be queried according to the context. Likewise, in block 350 an external data store can be queried according to the context. As such, in block 360 a panel display of contextually related data can be constructed from the internally sourced data and in block 370, a panel display of contextually related data can be constructed from the externally sourced data. Finally, the panels can be inserted into the user interface in block 380 and the process can return to block 310.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for displaying contextually relevant heterogeneously sourced data in a business application, the method comprising:
generating a user interface for a business application comprising a display of a record of a contact stored in a local data store;
determining a context for the contact;
retrieving contextually relevant data according to the context from both the local data store that is part of the business application and also an external data source that is external to the business application from over a computer communications network; and,
displaying the contextually relevant data from the local data store in a panel adjacent to the display of the record of the contact in the user interface, and also the contextually relevant data from the external data source in an additional panel adjacent to the display of the record of the contact in the user interface.

2. The method of claim 1, wherein the context is an industry of a business enterprise associated with the contact.

3. The method of claim 1, wherein the context is a business enterprise associated with the contact.

4. The method of claim 1, wherein the context is an individual employed by the contact.

5. The method of claim 1, further comprising:
retrieving additional contextually relevant data according to a context of the contextually relevant data for the context of the contact; and,
displaying the additional contextually relevant data in a panel adjacent to the display of the record of the contact in the user interface.

6. The method of claim 1, wherein the external data source is an e-mail server and the contextually relevant data is an e-mail message received from or transmitted to the contact.

7. The method of claim 1, wherein the external data source is an e-mail server and the contextually relevant data is an e-mail message with the context included in a subject line of the e-mail message.

8. A business data processing system configured for displaying contextually relevant heterogeneously sourced data, the system comprising:
a host computing system comprising memory and at least one processor;
a business application executing in the memory of the host computing system and providing a user interface comprising a display of a record of a contact stored in a local data store; and,
a contextual data retrieval module coupled to the business application, the module comprising program code enabled to determine a context for the contact, to retrieve contextually relevant data according to the context from both the local data store that is part of the business application and also an external data source that is external to the business application from over a computer communications network, and to direct the business application to display the contextually relevant data from the local data store in a panel adjacent to the display of the record of the contact in the user interface, and also the contextually relevant data from the external data source in an additional panel adjacent to the display of the record of the contact in the user interface.

9. The system of claim 8, wherein the context is an industry of a business enterprise associated with the contact.

10. The system of claim 8, wherein the context is a business enterprise associated with the contact.

11. The system of claim 8, wherein the context is an individual employed by the contact.

12. The system of claim 8, wherein the program code of the module is further enabled to retrieve additional contextually relevant data according to a context of the contextually relevant data for the context of the contact, and to direct the business application to display the additional contextually relevant data in a panel adjacent to the display of the record of the contact in the user interface.

13. The system of claim 8, wherein the external data source is an e-mail server and the contextually relevant data is an e-mail message received from or transmitted to the contact.

14. The system of claim 8, wherein the external data source is an e-mail server and the contextually relevant data is an e-mail message with the context included in a subject line of the e-mail message.

15. A computer program product for displaying contextually relevant heterogeneously sourced data in a business application, the computer program product comprising:
a computer readable storage medium having computer readable program code embodied therewith, the computer readable program code comprising:
computer readable program code for generating a user interface for a business application comprising a display of a record of a contact stored in a local data store;
computer readable program code for determining a context for the contact;
computer readable program code for retrieving contextually relevant data according to the context from both the local data store that is part of the business application and also an external data source that is external to the business application from over a computer communications network; and,
computer readable program code for displaying the contextually relevant data from the local data store in a panel adjacent to the display of the record of the contact in the user interface, and also the contextually relevant data from the external data source in an additional panel adjacent to the display of the record of the contact in the user interface.

16. The computer program product of claim 15, wherein the context is an industry of a business enterprise associated with the contact.

17. The computer program product of claim 15, wherein the context is a business enterprise associated with the contact.

18. The computer program product of claim 15, wherein the context is an individual employed by the contact.

19. The computer program product of claim 15, further comprising:
computer readable program code for retrieving additional contextually relevant data according to a context of the contextually relevant data for the context of the contact; and,
computer readable program code for displaying the additional contextually relevant data in a panel adjacent to the display of the record of the contact in the user interface.

20. The computer program product of claim 15, wherein the external data source is an e-mail server and the contextually relevant data is an e-mail message received from or transmitted to the contact.

21. The computer program product of claim 15, wherein the external data source is an e-mail server and the contextually relevant data is an e-mail message with the context included in a subject line of the e-mail message.
